(19) United States
(12) Patent Application Publication
(10) Pub. No.: US 2026/0359386 A1
(43) Pub. Date: Nov. 12, 2026

(54) MATRIX ENGINE WITH MATRIX AND VECTOR PRODUCTS

(71) Applicant: ADVANCED MICRO DEVICES, INC., Santa Clara, CA (US)

(72) Inventors: Stuart David Simpson Biles, Bury St. Edmunds (GB); Brian William Thompto, Austin, TX (US); Michael Estlick, Fort Collins, CO (US); Glendon Leo Akins III, Fort Collins, CO (US); Douglas John Cutter, Fort Collins, CO (US); Mahadev Deshpande, Fort Collins, CO (US)

(21) Appl. No.: 19/434,891

(22) Filed: Dec. 29, 2025

Related U.S. Application Data
(60) Provisional application No. 63/771,554, filed on Mar. 13, 2025.

(51) Int. Cl. G06F 17/16; G06F 7/78; G06F 9/30

(52) U.S. Cl. CPC G06F 17/16; G06F 7/78; G06F 9/30036

(57) ABSTRACT

A processing system includes a matrix engine that implements matrix-matrix operations, vector-vector operations, and matrix-vector operations. The matrix engine includes a set of arithmetic elements to execute a set of computations. The matrix engine further includes one or more multiplexors that are able to, based on an instruction, select one or more of the arithmetic elements to provide output data as the input data for a subsequent operation. This allows the matrix engine to sequence the inputs to the arithmetic elements, across different operations, in any of a variety of ways, and thus implement a corresponding variety of matrix operations, including matrix multiplication, vector dot products, matrix transposition and others.

### BACKGROUND

Processing systems are sometimes used to execute machine learning, artificial intelligence (AI), and similar applications. For example, some processing systems implement one or more machine learning models (MLMs). To implement such a model, the processing system executes a set of mathematical operations corresponding to the MLM. For example, to implement an MLM, a processing system sometimes executes a set of matrix multiplication operations in order to multiply an activation matrix, representing a set of activations for a layer of the MLM, with a weight matrix, representing weights associated with the MLM layer. The MLM or other program also executes vector operations, such as calculating vector dot products between two vectors. In order to increase efficiency, some processing systems employ specially-designed and configured arithmetic circuitry to execute these mathematical operations, such as dedicated matrix engines and vector engines. However, existing approaches to this dedicated circuitry are relatively inflexible and inefficient.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system including matrix engines configured to perform both vector and matrix operations using the same arithmetic elements in accordance with some implementations.

FIG. 2 is an example of a matrix engine of the processing system of FIG. 1 wherein the matrix engine supports using the outputs of the arithmetic elements as inputs for subsequent operations, thereby supporting a variety of matrix and vector operations.

FIG. 3 is a block diagram of an arithmetic element of the matrix engine of FIG. 2, illustrating output ports to allow the outputs of the arithmetic element to be looped back as an input for a subsequent operation in accordance with some implementations.

FIG. 4 is a diagram illustrating an example of the matrix engine of FIG. 2 executing a matrix or vector operation by sequencing provision of vector inputs to the arithmetic elements in accordance with some implementations.

FIG. 5 is a diagram illustrating another example of the matrix engine of FIG. 2 executing a matrix or vector operation by sequencing provision of vector inputs to the arithmetic elements in accordance with some implementations.

FIG. 6 is a diagram illustrating an example of the matrix engine of FIG. 2 using different portions of a tile register as input vectors for a vector or matrix operation in accordance with some implementations.

FIG. 7 is a flow diagram of a method of executing vector and matrix operations at a matrix engine in accordance with some implementations.

### DETAILED DESCRIPTION

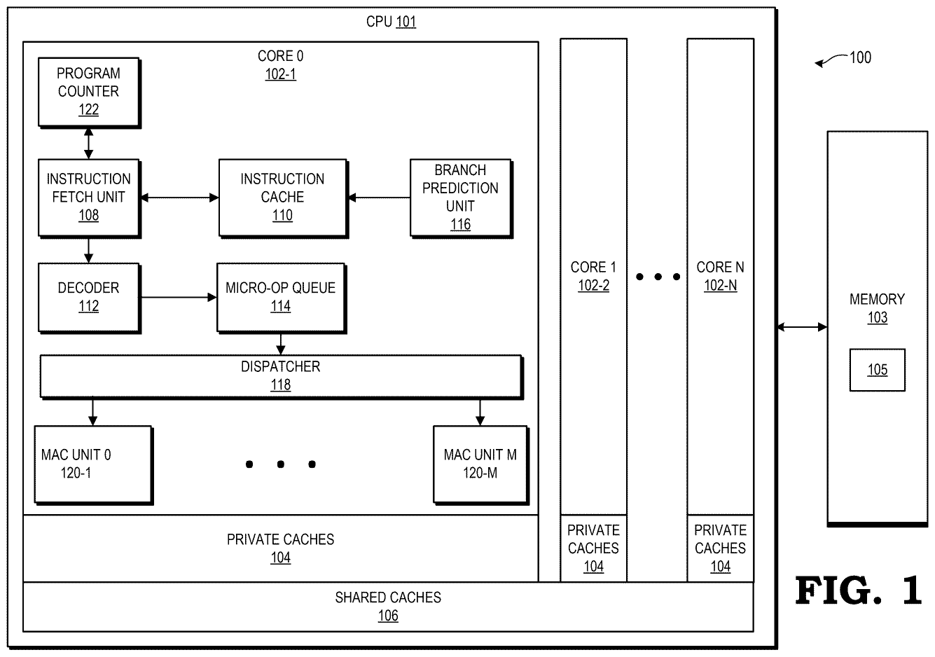

FIGS. 1-7 illustrate techniques for implementing a matrix engine that supports matrix-matrix operations (that is, operations employing two matrices as input operands), vector-vector operations, and matrix-vector operations. The matrix engine includes a set of arithmetic elements to execute a set of computations (e.g., multiply, accumulate). The matrix engine further includes one or more multiplexors that are able to, based on an instruction, select one or more of the arithmetic elements to provide output data as the input data for a subsequent operation. This allows the matrix engine to sequence the inputs to the arithmetic elements, across different operations, in any of a variety of ways, and thus implement a corresponding variety of matrix operations, including matrix multiplication, vector dot products, matrix transposition and others. Furthermore, in some implementations the inputs are provided for the different operations locally, using the arithmetic elements and input registers of the matrix engine itself, rather than from a centralized set of registers. The matrix engine thereby supports a variety of matrix and vector operations while conserving processing resources.

To further illustrate, in some implementations a processor is generally configured to execute programs or applications including machine learning, neural network, artificial intelligence operations, referred to generally herein as artificial intelligence operations. Such operations typically require execution of a relatively large number of vector operations and matrix operations, such as outer product operations, dot product operations, multiplication (matrix multiplication, vector multiplication, or a combination) operations, and the like. The matrix and vector operations are implemented by circuitry, referred to as arithmetic element units, that execute the arithmetic operations (e.g., multiplication, accumulation, or a combination thereof) on corresponding elements of the matrix operands. Conventionally, the matrix operations are implemented by one engine (that is, by dedicated arithmetic elements and supporting circuitry) and the vector operations are implemented by another engine.

However, at least some matrix operations are able to be implemented as a series of vector operations with appropriate inputs. For example, matrix multiplication is able to be implemented with a series of vector outer product operations. For example, the multiplication of two matrices A and B is able to be implemented as a sum of column-by-row outer products of the corresponding vectors. Accordingly, using the techniques described herein, a matrix engine implements matrix operations, such as matrix multiplication, by applying the different rows and columns of one or more input matrices to the arithmetic elements, and the output vectors of the arithmetic elements themselves, in a specified sequence, wherein the sequence is defined by the particular operation being executed. Thus, for example, in some implementations the matrix engine executes matrix-matrix multiplication (that is, multiplies two input matrices) by executing a sequence of vector outer product operations and accumulating the results of the sequence. By executing different sequences of vector inputs (e.g., in response to corresponding processor instructions), the matrix engine implements matrix-matrix operations (operations with two matrices as input operands), vector-vector operations (operations with two vectors as input operands), matrix-vector operations (operations with a matrix as one input operand and a vector as the other input operand), and the like, or any combination thereof.

For some operations, such as matrix multiplication, the matrix engine employs the output of one or more rows, columns, or a combination, of the arithmetic elements. In some implementations, to efficiently implement such operations, the matrix engine includes one or more multiplexers configured to select, based on a corresponding instruction, the output of a row, column, or both, of the arithmetic element, and to apply the selected output as an input vector for the next operation in the sequence. Each arithmetic element includes read ports to allow the element to be read out by the multiplexer as a part of a row, a column, or both. This allows the matrix engine to efficiently implement operations in a sequence that employ the output of previous operations in the sequence, rather than storing that output in a register or memory, and thus conserving processor resources.

In some implementations, to further enhance flexibility and performance, the matrix engine includes or is connected to one or more tile registers configured to store two-dimensional tiles of data, arranged logically in rows and columns. Thus, the tile register, in some configurations and circumstances, stores an NxM matrix. The matrix engine is configured, in response to a corresponding instruction or operation, selectively access rows or columns of the one or more tile registers. This allows the matrix engine to perform matrix or vector operations by applying the selected rows or columns as vector inputs to the arithmetic elements, wherein the selection and application of the different rows or columns is based on the instruction. Furthermore, in some implementations the one or more tile registers are local to the matrix engine, reducing the overhead and energy consumption associated with the selection and application of the vector inputs.

FIG. 1 illustrates a processing system 100 utilizing at least one CPU 101 configured to execute instructions for one or more applications represented by instructions and other data stored in one or more system memories 103 in accordance with some implementations. The processing system 100 is generally configured to execute the applications (e.g., computer programs) to carry out operations on behalf of an electronic device. Accordingly, in different implementations, the processing system 100 is part of one of a number of electronic devices, such as a desktop computer, laptop computer, server, smartphone, game console, tablet, and the like.

To execute these applications, the CPU 101 includes an architecture having one or more processor cores 102 each associated with one or more private caches 104 and one or more shared caches 106. These private caches 104 each include a volatile memory, non-volatile memory, or both included in or otherwise connected (e.g., by a data fabric or bus) to a processor core 102 and are each only accessible by a corresponding processor core 102. As an example, CPU 101 includes a respective first private cache (e.g., L0 cache), and a respective second private cache 104 (e.g., L1 cache) that are included in or otherwise connected to a corresponding processor core 102 such that they are each only accessible by the corresponding processor core 102. Additionally, the shared caches 106 each include a volatile memory, non-volatile memory, or both and are each connected (e.g., by a data fabric or bus) to and accessible by two or more processor cores 102. For example, CPU 101 includes a last-level cache (e.g., L3 cache) connected to and accessible by two or more processor cores (e.g., core 0 102-1, core 1 102-2, core N 102-N). Each of the private caches 104 and shared caches 106 are configured to store instructions to be executed by CPU 101, data (e.g., operands, values) used in the execution of the instructions, data resulting from the execution of one or more instructions, or any combination thereof. According to some implementations, for each processor core 102, the private caches 104, shared caches 106, and a system memory (e.g., random access memory (RAM)) accessible by the processor core 102 are arranged in a hierarchy based on the respective sizes of the caches and system memory.

CPU 101 is configured to execute instructions (e.g., instructions 105 stored in system memory 103) of one or more threads based on the type of architecture (e.g., an instruction set architecture (ISA)) associated with CPU 101. For example, based on CPU 101 having a complex instruction set computer (CISC) instruction set architecture (e.g., x86 architecture), CPU 101 is configured to execute instructions from a CISC instruction set (e.g., x86 instruction set). Additionally, based on CPU 101 having a reduced instruction set compute (RISC) instruction set architecture (e.g., ARM instruction set architecture, AVR instruction set architecture), CPU 101 is configured to execute instructions from a RISC instruction set (e.g., ARM instruction set, AVR instruction set). To execute instructions from an instruction set for one or more threads, CPU 101 includes one or more processor cores 102 each including a program counter 122, instruction fetch unit 108, instruction cache 110, decoder 112, micro-op queue 114, branch prediction unit 116, dispatcher 118, and one or more scalable matrix engines 120. In implementations, each processor core 102 is configured to concurrently execute instructions for two or more threads. Though the example implementation presented in FIG. 1 shows CPU 101 as including three processor cores (102-1, 102-2, 102-N) representing an N number of processor cores 102, in other implementations, CPU 101 may include any number of processor cores 102 based on design choices.

The program counter 122 of a processor core 102 includes a register configured to sequentially store data (e.g., pointers) representing the memory addresses of instructions in one or more threads to be executed for an application. As an example, the program counter 122 stores data indicating the physical or virtual addresses of one or more instructions of a thread in the order in which the instructions are to be executed. Based on the memory addresses indicated in the program counter 122, the instruction fetch unit 108 of the processor core 102 fetches instructions from the instruction cache 110 to execute. This instruction cache 110, for example, includes at least a portion of a private cache 104 accessible by the processor core 102 arranged in a hierarchy with one or more other private caches 104, shared caches 106, and the system memory also accessible by the processor core 102. According to implementations, the instruction fetch unit 108 first requests an instruction at the memory address indicated by the program counter 122 from the instruction cache 110. Based on the instruction not being in the instruction cache 110, a controller of the instruction cache 110 then requests the instruction from the cache at a next level of the hierarchy. The controllers of the caches then continue requesting the instruction in this way until the instruction is found in a cache or the instruction is requested from the system memory, at which point the instruction is provided to the instruction fetch unit 108. In some implementations, the processor core 102 is configured to prefetch one or more instructions to be performed for the thread into one or more caches, such as instruction cache 110.

After the instruction fetch unit 108 has retrieved the instruction indicated by the program counter 122, the instruction fetch unit 108 provides the instruction to decoder 112 and increments the program counter 122 so as to indicate the next instruction to be executed. As an example, after retrieving an instruction, instruction fetch unit 108 stores the instruction in an instruction register included in or otherwise connected to decoder 112. The decoder 112 includes circuitry configured to decode the instruction to determine the operation code (“op-code”) of the instruction, one or more operands associated with the instruction, or both. For example, from the instruction, the decoder 112 determines an op-code (e.g., micro op-code) indicating a type of instruction (e.g., load instruction, store instruction, ADD instruction, subtract instruction, branch instruction, conditional branch instruction, shift instruction) and which scalable matrix engine 120 is to execute the instruction. After decoding the instruction, the decoder 112 stores data indicating the op-code and operands of the instruction in a micro-op queue 114. This micro-op queue 114 includes one or more queues configured to store the decoded op-code (e.g., micro op-code) of instructions before the decoded op-code is provided to the scalable matrix engine 120 indicated by the op-code. According to some implementations, based on an instruction indicating a conditional branch instruction, branch prediction unit 116 is configured to predict one or more additional instructions. For example, from the conditional branch instruction, the branch prediction unit 116 determines a predicted branch (e.g., a branch predicted to be taken when the instruction is executed) and an unpredicted branch (e.g., a branch not predicted to be taken when the instruction is executed). Based on the predicted branch, branch prediction unit 116 then determines one or more additional instructions to be executed and, in implementations, instructs instruction fetch unit 108 to retrieve these additional instructions.

The data indicating the op-code and operands associated with the instruction is provided from the micro-op queue 114 to a dispatcher 118 that includes circuitry configured to route the data to the corresponding scalable matrix engine 120 indicated in the op-code. A scalable matrix engine 120 of the processor core 102 includes circuitry configured to execute the op-code indicated in the data provided by dispatcher 118. For example, a scalable matrix engine 120 includes a floating point unit, integer unit, or the like. Further, each scalable matrix engine 120 includes a renamer that includes circuitry configured to allocate one or more registers of the scalable matrix engine 120 to store the operands of the instructions. For example, the renamer translates architectural registers indicated by the op-code of the instruction to one or more physical registers of the scalable matrix engine 120. After renaming the registers associated with the instruction, scheduling circuitry (e.g., scheduling queues) of the scalable matrix engine 120 provides data representing operations to be performed for the instruction to one or more execution pipes. For example, based on the operands and type of instruction, the scheduling circuitry provides data representing the operations to be performed to corresponding execution pipes. Each of these execution pipes of a scalable matrix engine 120 includes circuitry configured to perform one or more respective operations indicated by the op-code associated with an instruction such as one or more arithmetic logic unit operations, address generation unit operations, floating point add operations, fused multiply-add operations, or the like. After an execution pipe has performed an operation for an instruction, the data resulting from the performance of the operation is stored in a private cache 104, shared cache 106, system memory 103, or any combination thereof accessible by the processor core 102.

As noted above, in implementations the system 100 is configured to execute instructions configured in accordance with at least one ISA and/or ISA extension. One such ISA is the aforementioned x86 ISA. The x86 ISA is a family of instruction sets primarily used by compute systems, such as processing system 100, utilizing central processing units (CPUs) (e.g., CPU 101) or similar processors from Intel Corp. and Advanced Micro Devices (AMD) Inc. The x86 ISA primarily is directed to CISC (Complex Instruction Set Computing), which means that its instruction set includes a large number of instructions, some of which are capable of performing multiple operations in a single instruction. In an x86 architecture, a processor uses a set of general-purpose registers to perform operations on data. These registers hold operands for operations and store intermediate results. The architecture also uses a stack for function calls and local variables, with the stack pointer keeping track of the top of the stack. PUSH and POP operations are used to manipulate the stack during program execution. An Instruction Pointer holds the address of the next instruction to be executed and is automatically updated as instructions are processed. Control flow instructions modify the value of the instruction pointer, allowing for conditional and unconditional jumps in the execution flow.

The x86 ISAs include a range of basic instruction types. Data movement instructions like MOV, PUSH, and POP are used to move data between registers, memory, and the stack. Arithmetic operations such as ADD, SUB, MUL, and DIV manipulate data in registers or memory. The architecture also supports control flow instructions, such as JMP (unconditional jump) and CALL (function call), as well as conditional jump instructions like JE (jump if equal) and JNE (jump if not equal), which rely on the processor's flags to determine whether to alter the flow of execution. Logical operations like AND, OR, XOR, and NOT are used to perform bitwise operations on data, while string operations like MOVSB (move string byte) and CMPSB (compare string byte) are designed to manipulate sequences of data. Additionally, system and interrupt instructions such as INT and IRET allow the processor to handle external events or internal errors by transferring control to interrupt service routines.

Over time, x86 processors have incorporated additional features, such as SIMD (Single Instruction, Multiple Data), which are accessed, instruction-wise, via ISA extensions to accelerate parallel computing tasks. One such set of x86 ISA extensions includes AVX (Advanced Vector Extensions), which is generally directed to improving the performance of computationally demanding applications by enabling more efficient SIMD operations. AVX enhances the x86 instruction set by offering powerful vector operations that significantly boost performance in tasks such as scientific computing, video processing, machine learning, and cryptography, where parallel data processing is crucial. One of the primary features of AVX is its wide vector registers. AVX extends the width of vector registers to 256 bits, which allows each register to hold up to eight single-precision (32-bit) floating-point numbers or four double-precision (64-bit) floating-point numbers. This increased register width enables processors to handle more data per operation, improving overall throughput and making data processing much more efficient. Moreover, AVX is designed to leverage SIMD parallelism, which means that a single instruction can perform the same operation on multiple data elements simultaneously. This parallelism is particularly beneficial for tasks like matrix multiplication or large-scale data processing, as one instruction can process multiple pieces of data at once, greatly speeding up computation. Another feature of AVX is its optimization for floating-point calculations. The instruction set supports efficient operations such as addition, multiplication, and dot products on vectorized data, which are common in applications that rely heavily on floating-point computation, including 3D rendering, scientific simulations, and signal processing. Additionally, some versions of AVX support Fused Multiply-Add (FMA) instructions, which allow a single instruction to multiply two numbers and then add the result to a third. This helps reduce the latency of calculations and improves precision, which is especially beneficial in areas like linear algebra and numerical simulations.

AVX also includes instructions that enhance performance, such as AVX-optimized arithmetic operations for floating-point vector calculations. Instructions like VADDPS and VMULPS perform vectorized addition and multiplication, respectively, while others, like VPERMILPS, allow for more complex operations like reordering elements in a vector. These instructions enable processors to handle large datasets more efficiently with fewer clock cycles.

In some implementations, the processing system 100 includes additional matrix-related features and a corresponding ISA extension to support higher compute density capabilities and to provide for operations to accelerate matrix math operations. These one or more extensions, referred to collectively herein as Advanced Computation Extension (ACE), augment AVX and scalar code with capabilities, including: ACE register state, including tile and block scale registers; data processing operations that consume AVX register input and operate on tile register state; data move operations to move data between ACE register state, AVX registers and memory; state and operations for system management. This ACE extension provides for integration between AVX vectors and ACE tile registers, combining high compute density tile processing operations with the comprehensive data processing features of AVX.

In some implementations, the processing system 100 includes, for example, a tile register file, containing a number of two-dimensional tile registers, each being, for example, 512-bits wide by 16 rows, with each row equivalent in size to a single AVX-512 vector. Each tile register row has width of 512-bits and includes a number of elements, dependent on the type of data being processed in the tile register. For example, in some implementations the processing system 100 supports 32-bit (FP32 or INT32) accumulator types and each ACE tile register row is therefore equivalent to 16 32-bit elements. In some implementations, the processing system 100 provides a number of tile registers wherein the number implemented is architecture specific.

In some implementations, each of the matrix engines 120 is configured to perform one or more matrix or vector operations based on operations received from the dispatcher 118. For purposes of description, the matrix engines 120 will be described with respect to performing outer product operations, but it will be appreciated that in some implementations the matrix engines 120 are configured to perform additional operations, such as dot product operations.

Based on operations received from the dispatcher 118, the matrix engines 120 are configured to perform outer product operations to compute, for example, small dimension matrix multiplication results. In some implementations, each outer product operation consumes two vectors (e.g., AVX vectors) as input operands. The input vectors are divided into elements equal to the number of rows or columns in the destination tile register. For example, in some implementations the input vectors are 512-bits in length and are divided into 16 elements of 32-bits. One input vector is used as a row input, the other as a column input. Each matrix engine includes a plurality of arithmetic elements arranged in rows and columns to receive the respective vector inputs. The outer product operation executes a dot product at every arithmetic element, using the intersecting row and column elements as input to each corresponding arithmetic element.

In some implementations, the matrix engines 120 include multiplexers connected to the input operand registers and also connected to corresponding read ports at each arithmetic element. Based on operations received from the dispatcher 118, the matrix engines 120 are configured to select either the input operand registers or the read ports of a column or row of the arithmetic elements. This allows the matrix engines 120 to employ the output of a row or column of arithmetic elements as an input vector for the next operation received from the dispatcher 118. Accordingly, based on different sequences of operations received from the dispatcher 118, the matrix engines 120 select and apply different vectors to the arithmetic elements, wherein at least some vectors in some sequences are selected from the rows, columns, or rows and columns of the arithmetic elements, without being transferred to a tile register or other output register. This allows the matrix engines 120 to efficiently execute a variety of vector-vector, matrix-matrix, and matrix-vector operations. For example, in some implementations, the matrix engines 120 are configured to execute, based on different instructions, matrix-matrix multiplication, matrix-vector multiplication, vector-vector multiplication, matrix permutation (e.g., permutation of rows and columns of a matrix), matrix transposition, per-element add operations with row or column reduction, identifications of maximum and minimum vector or matrix elements, and the like, or any combination thereof.

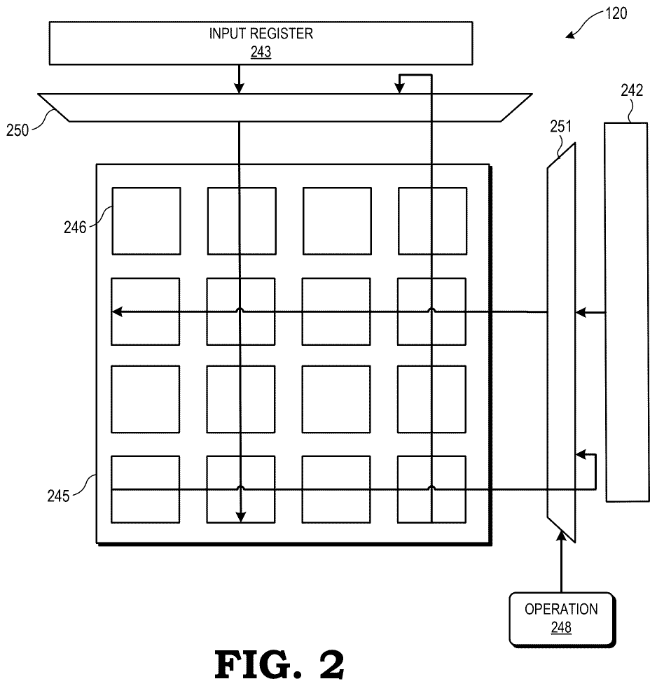

FIG. 2 illustrates a block diagram of the matrix engine 120 in accordance with some implementations. In the illustrated implementation, the matrix engine 120 includes input registers 242 and 243, multiplexers 250 and 251, and set 245 of arithmetic elements. The input registers 242 and 243 are each configured to store an input operand vector (designated vectors A and B for purposes of description). The input registers 242 and 243 are illustrated as part of the matrix engine 120 in accordance with some implementations. However, it will be appreciated that in some implementations, the input registers 242 and 243 are located remotely from the matrix engine 120. Furthermore, it will be appreciated that in some implementations, the input operand vectors A and B are selectively provided from any of a plurality of input registers, including one or more of a set of vector registers, from rows or columns of one or more tile registers, or any combination thereof.

The set 245 of arithmetic elements includes a plurality of individual arithmetic elements (e.g., arithmetic element 246). In the depicted example, the set 245 includes a 4×4 group of arithmetic elements. That is, the set 245 includes 16 arithmetic elements arranged in 4 rows (with 4 elements each) and 4 columns (with 4 elements each). Each arithmetic element (e.g., arithmetic element 246) is configured to receive corresponding matrix element inputs as described further below, with one input being received along the row of the element and the other input being received along the column. Each arithmetic element includes circuitry configured to multiply and sum the input values.

The multiplexers 250 and 251 include inputs connected to the input registers 243 and 242, respectively. In addition, the multiplexer 250 includes different inputs connected to read ports of the different columns of arithmetic elements in the set 245. Similarly, the multiplexer 251 includes different inputs connected to read ports of the different rows of arithmetic elements in the set 245. The multiplexers 250 and 251 also include control inputs to receive control information from an executing operation 248 (for clarity, the control input is only illustrated for the multiplexer 251). Based on the control information, the multiplexer 250 selects either the data at the input register 243 or the data at a selected one of the columns of arithmetic elements, and provides the selected data as the input vector B for the operation 248. Similarly, based on the control information, the multiplexer 251 selects either the data at the input register 243 or the data at a selected one of the rows of arithmetic elements and provides the selected data as the input vector A for the operation 248. Thus, the matrix engine 120 is configured to provide output data for one operation as an input vector for a subsequent operation, directly from the arithmetic elements themselves, rather than by storing the output data of the arithmetic elements in a register. The matrix engine 120 thereby enables efficient execution of different sequences of operations, including sequences corresponding to vector-vector multiplication, matrix-matrix multiplication, vector-matrix multiplication, and other operations.

For example in some implementations, for a vector-vector operation, the processing system 100 implements a relative to an outer product operation, which targets a row in a tile register, as follows:
“Tile Vector Product” TVP<input format><accumulator format>tmm0, zmm1, zmm2, <imm|r32>

The operation updates tmm0[row], where row is specified by an immediate or general purpose register value. The operation generates a sum of products for every lane in a register zmm1 with the contents of register zmm2[row] (i.e. the row'th lane of zmm2), accumulating with the corresponding accumulate value in the tile register tmm0[row]. In some implementations, this operation is useful for matrix-vector multiplication operations. The Tile Vector Product allows the use of multiple rows of the tile register (and register file) to build up a very wide vector result. The ACE register file has 4× the architectural capacity as the AVX register file, so that the TVP allows a larger vector result to be accumulated between storing the result out to memory.

In some implementations, the matrix engine 120 implements an operation set forth by the following pseudo-code loop:
LD zmm0, matrix[n][k]
LD zmm1, matrix[n+1*NSTEP][k]
LD zmm2, matrix[n+2*NSTEP][k]
LD zmm3, matrix[n+3*NSTEP][k]
LD zmm4, matrix[n+4*NSTEP][k]
LD zmm5, matrix[n+5*NSTEP][k]
LD zmm6, matrix[n+6*NSTEP][k]
LD zmm7, matrix[n+7*NSTEP][k]
LD[broadcast] zmm10, vector[k]//store vector[k] across all lanes
TVP tmm0, zmm0, zmm10, #0
TVP tmm0, zmm1, zmm10, #1
TVP tmm0, zmm2, zmm10, #2
TVP tmm0, zmm3, zmm10, #3
TVP tmm0, zmm4, zmm10, #4
TVP tmm0, zmm5, zmm10, #5
TVP tmm0, zmm6, zmm10, #6
TVP tmm0, zmm7, zmm10, #7

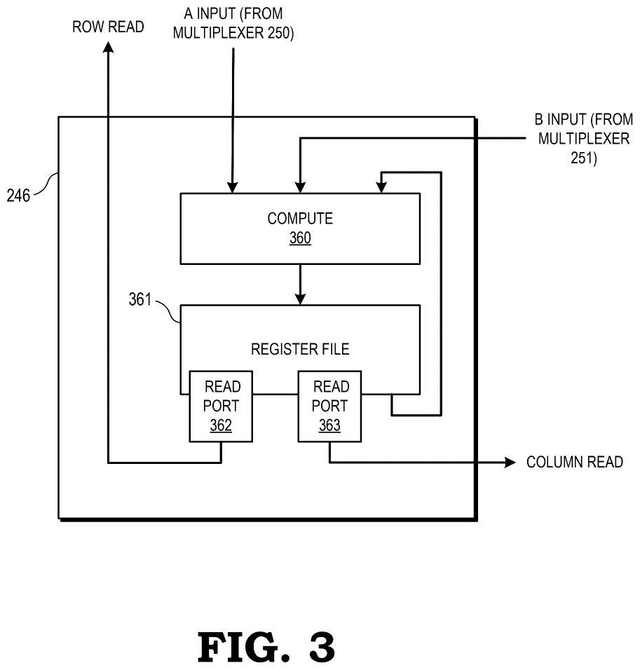

FIG. 3 illustrates a block diagram of the arithmetic element 246 in accordance with some implementations. In the example of FIG. 3, the arithmetic element 246 includes compute circuitry 360, and a register file 361. The compute circuitry 260 includes an input connected to an output of the multiplexer 250, an input connected to the output of the multiplexer 251 an input connected to the register file 361, and an output. The compute circuitry 360 is circuitry generally connected and configured to multiply the input data received from the multiplexer 250 (the A vector input) with the input data received from the multiplexer 251 (the B input data) and to accumulate the result with the data received from the register file 261.

The register file 361 is a set of registers including an input connected to the output of the compute circuitry 360. In some implementations, the register file 361 includes a plurality of registers, and selects one register as the active register to store input data and provide output data, wherein the selection is based on a register renaming scheme implemented by the processing system 100. The register file 361 includes read ports 362 and 363 connected to inputs of the multiplexers 250 and 251 respectively. The read ports 362 and 363 allow the multiplexers 250 and 251 to read the contents of the active register of the register file 361, and thus allow the multiplexers 250 and 251 to select the data stored at the register file 361 as a portion of a vector input operand for a subsequent operation.

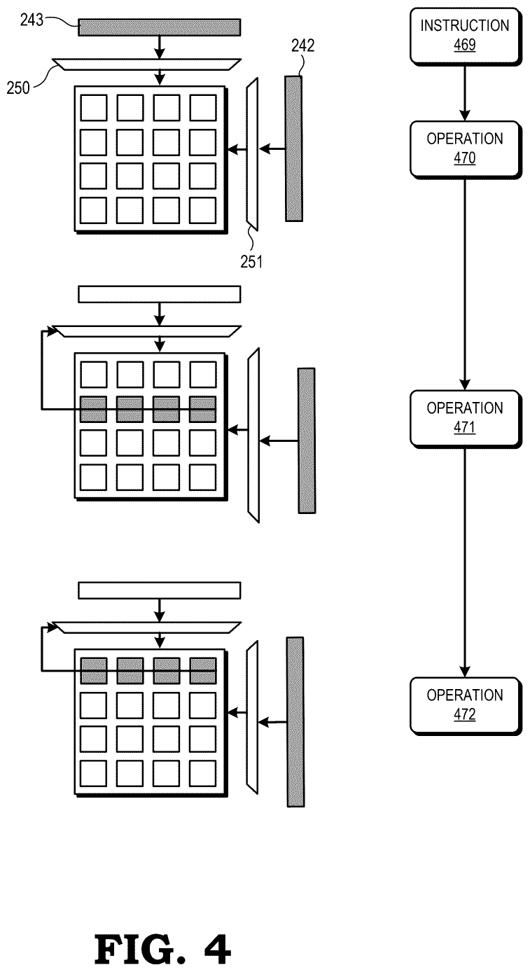

FIG. 4 illustrates an example sequence of vector inputs applied to the set 245 of arithmetic elements in accordance with some implementations. In the depicted example, the decoder 112 has decoded an instruction 469 into a set of operations, designated operation 470, operation 471, and operation 472. The dispatcher 118 dispatches these operations in sequence to one of the matrix engines 120 (e.g., matrix engine 120-1). Each of the operations 470-472 selects vector inputs from a different set of input sources. The input sources for each operation are illustrated in the Figures by a gray fill.

To illustrate, when operation 470 is executed by the matrix engine 120, the operation selects the contents of the input registers 242 and 243 as the data for input vectors A and B, respectively. That is, the operation 470 applies control information to the multiplexers 251 and 250 so that the input registers 242 and 243 are selected as the sources of the input vectors A and B. The set 245 of arithmetic elements executes the specified mathematical operations (e.g., multiply and accumulate) using the provided input vectors.

For operation 471 (the operation following operation 470), the operation selects the contents of the input register 242 as the input vector A for the operation. However, for the input vector B, the operation 471 selects the data at the second row of the set 245 of arithmetic elements. That is, the operation 471 applies control information to the multiplexers 250 so that the data stored at the registers of the second row of arithmetic elements is selected as the source of the input vector B. As with operation 470, the set 245 of arithmetic elements executes the specified mathematical operations (e.g., multiply and accumulate) using the provided input vectors.

For operation 472 (the operation following operation 471), the operation selects the contents of the input register 242 as the input vector A for the operation. However, for the input vector B, the operation 472 selects the data at the first row of the set 245 of arithmetic elements. That is, the operation 472 applies control information to the multiplexers 250 so that the data stored at the registers of the first row of arithmetic elements is selected as the source of the input vector A. As with operations 470 and 471, the set 245 of arithmetic elements executes the specified mathematical operations (e.g., multiply and accumulate) using the provided input vectors. Thus, in the example of FIG. 3, the sequence of operations 470-472 apply input vectors from different sources, including in some cases applying the data at rows of the arithmetic elements as an input vector for an operation.

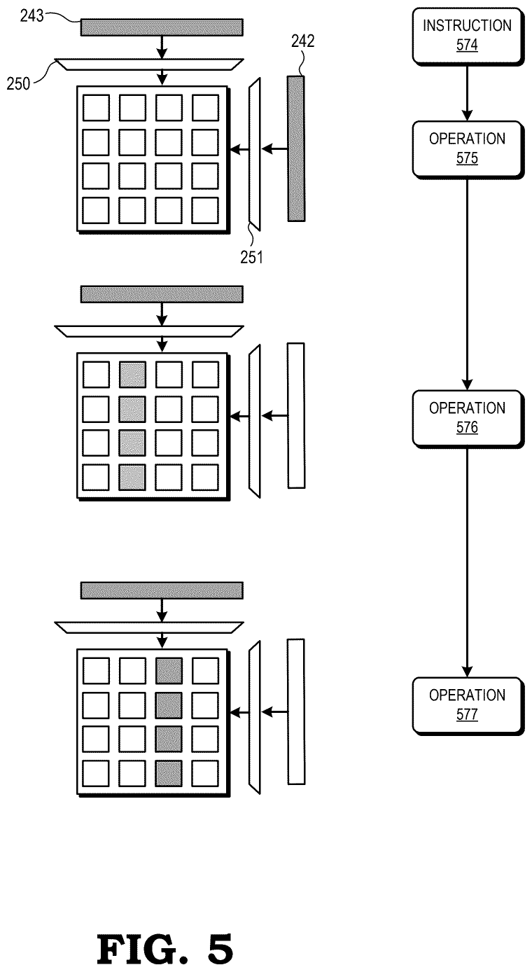

FIG. 5 illustrates another example sequence of vector inputs applied to the set 245 of arithmetic elements in accordance with some implementations. In the depicted example, the decoder 112 has decoded an instruction 574 into a set of operations, designated operation 575, operation 576, and operation 577. The dispatcher 118 dispatches these operations in sequence to one of the matrix engines 120 (e.g., matrix engine 120-1). Similar to the example of FIG. 4, each of the operations 575-577 selects vector inputs from a different set of input sources. However, it is assumed that the instruction 574 is different from the instruction 469, and that at least some of the operations 575-577 are different from the operations 470-472, and select input vectors from different sources.

To illustrate, when operation 575 is executed by the matrix engine 120, the operation selects the contents of the input registers 242 and 243 as the data for input vectors A and B, respectively. That is, the operation 575 applies control information to the multiplexers 251 and 250 so that the input registers 242 and 243 are selected as the sources of the input vectors A and B. The set 245 of arithmetic elements executes the specified mathematical operations (e.g., multiply and accumulate) using the provided input vectors. Operation 575 is thus similar to operation 470 of FIG. 4, and in some implementations the operations are the same or equivalent operations.

For operation 576 (the operation following operation 575), the operation selects the contents of the input register 243 as the input vector B for the operation. However, for the input vector A, the operation 576 selects the data at the second column (from the left) of the set 245 of arithmetic elements. That is, the operation 576 applies control information to the multiplexers 250 so that the data stored at the registers of the second column of arithmetic elements is selected as the source of the input vector B. As with operation 575, the set 245 of arithmetic elements executes the specified mathematical operations (e.g., multiply and accumulate) using the provided input vectors.

For operation 577 (the operation following operation 576), the operation selects the contents of the input register 243 as the input vector B for the operation. However, for the input vector A, the operation 577 selects the data at the third column of the set 245 of arithmetic elements. That is, the operation 577 applies control information to the multiplexers 250 so that the data stored at the registers of the third column of arithmetic elements is selected as the source of the input vector B. As with operations 575 and 576, the set 245 of arithmetic elements executes the specified mathematical operations (e.g., multiply and accumulate) using the provided input vectors. Thus, in the example of FIG. 3, the sequence of operations 575-577 apply input vectors from different sources, including in some cases applying the data at rows of the arithmetic elements as an input vector for an operation. In addition, the operations 575-577 apply input vectors from different sources at different times than the operations 470-472, reflecting the different matrix or vector operations requested by the instructions 574 and 469, respectively.

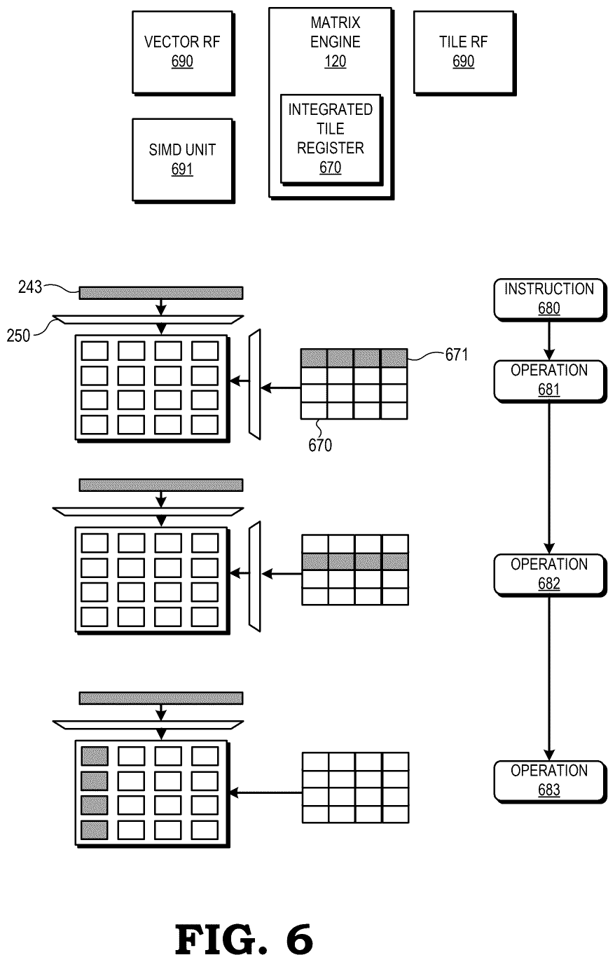

In some implementations, for some instructions the matrix engine 120 employs vector input data stored at a tile register. An example is illustrated at FIG. 6 in accordance with some implementations. In the illustrated example, the matrix engine 120 is configured to access data from any of a number of sources, including a vector register file 690, an integrated tile register 670, and a tile register file 690. In some implementations, the integrated tile register 670 is accessible only to the elements of the matrix engine 120, while the vector register file 690 and the tile register file 690 include vector and tile registers, respectively, accessible to the matrix engine 120 and to other circuitry of the processing system 100, such as a SIMD unit 691.

In the example of FIG. 6, the matrix engine 120 executes an instruction 680. It is assumed for purposes of the example that the instruction 680 designates portions of a tile register 670 to be used as vector inputs for a matrix operation. In particular, the tile register 670 includes a plurality of rows (e.g., row 671), and the instruction 680 is assumed to designate the first two rows of the tile register 670 as vector inputs for a matrix operation. For example, in some embodiments each row of the tile register 670 corresponds to a different index value, and the instruction 680 identifies the portions of the tile register 670 to be used as vector inputs by identifying the indexes of the portions (e.g., rows) that are to be employed for each operation. It will be appreciated that in some implementations, the instruction 680 designates columns instead of rows. Furthermore, in some implementations, the instruction 680 identifies different portions of the tile register 670 for the A and B input vectors. In some implementations, the instruction 680 indicates portions of the tile register 670 as the input vector B for different operations, and designates portions of another tile register (not shown) as the input vector A for different operations.

Returning to the example of FIG. 6, the decoder 112 decodes the instruction 680 into a set of operations, designated operation 681, operation 682, and operation 683. The dispatcher 118 dispatches these operations in sequence to one of the matrix engines 120 (e.g., matrix engine 120-1). Similar to the example of FIG. 4, each of the operations 81-683 selects vector inputs from a different set of input sources. However, it is assumed that the instruction 680 is different from the instruction 469.

To illustrate, when operation 681 is executed by the matrix engine 120, the operation selects the contents of the input registers 242 as the data for input vector A and the first row (row 671) of the tile register 670 as the input vector B. That is, the operation 681 applies control information to the multiplexers 251 and 250 so that the input register 242 and the first row of the tile register 670 are respectively selected as the sources of the input vectors A and B. The set 245 of arithmetic elements executes the specified mathematical operations (e.g., multiply and accumulate) using the provided input vectors.

For operation 682 (the operation following operation 681), the operation selects the contents of the input register 242 as the input vector A for the operation. For the input vector B, the operation 682 selects the data at the second row of the tile register 670. That is, the operation 682 applies control information to the multiplexers 250 and 251 so that the data stored at the register 243 and the second row of the tile register 670 are respectively selected as the source of the input vector A and the input vector B. As with operation 681, the set 245 of arithmetic elements executes the specified mathematical operations (e.g., multiply and accumulate) using the provided input vectors.

For operation 683 (the operation following operation 682), the operation selects the contents of the input register 242 as the input vector A for the operation. However, for the input vector B, the operation 683 selects the data at the first column of the set 245 of arithmetic elements. That is, the operation 683 applies control information to the multiplexer 251 so that the data stored at the registers of the first column of arithmetic elements is selected as the source of the input vector B. As with operations 681 and 682, the set 245 of arithmetic elements executes the specified mathematical operations (e.g., multiply and accumulate) using the provided input vectors.

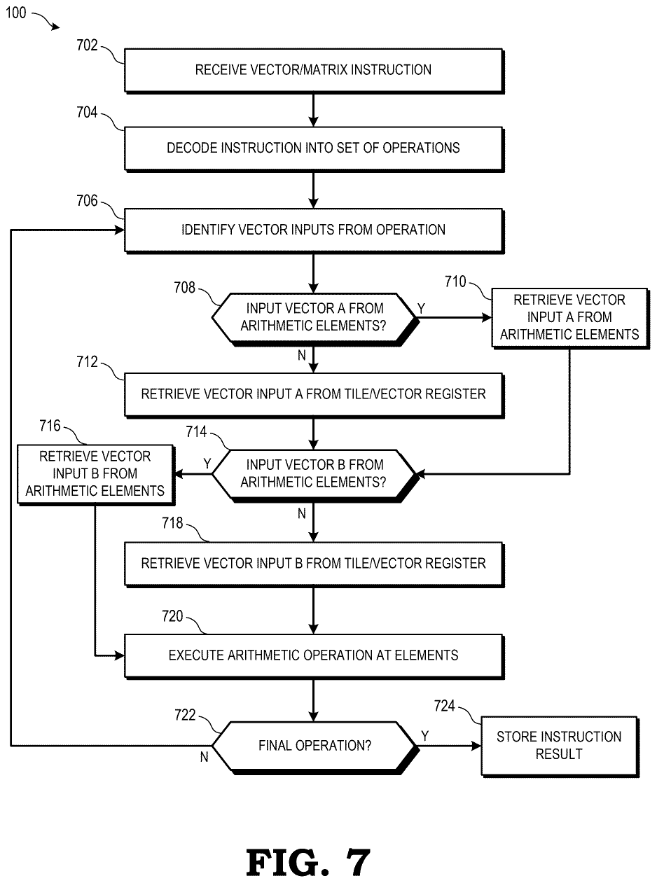

FIG. 7 illustrates a flow diagram of a method 700 of executing vector and matrix operations at a matrix engine in accordance with some implementations. For purposes of description, the method 700 is described with respect to an example implementation at the processing system 100 of FIG. 1, but it will be appreciated that in other implementations the method 700 is implemented at a processing system having a different configuration.

At block 702, the instruction fetch unit 108 provides a vector or matrix instruction to the decoder 112. The method 700 is further described with respect to an example wherein the instruction is a matrix instruction. At block 704, the decoder 112 decodes the matrix instruction into a sequence of operations, and sends the sequence of operations to one of the matrix engines 120 via the dispatcher 118.

For the first operation in the sequence, at block 706 the matrix engine 120 identifies the source of the vector inputs A and B, and in particular whether each input is to come from a vector or tile register, or from a row or column of the set 245 of arithmetic elements. At block 708, the matrix engine 120 determines if the vector input A source is a column of the set 245 of arithmetic elements. If so, the method flow moves to block 710 and the matrix engine 120 sets the multiplexer 250 so that the vector input A is retrieved from the registers of the selected column. The method then proceeds to block 714, described below. If, at block 708, the matrix engine 120 determines that the vector input A source is a vector register or portion of a tile register, the method flow moves to block 712 and the matrix engine 120 sets the multiplexer 250 so that the vector input A is retrieved from the vector register or selected portion of the tile register. The method flow then proceeds to block 714.

At block 714, the matrix engine 120 determines if the vector input B source is a row of the set 245 of arithmetic elements. If so, the method flow moves to block 716 and the matrix engine 120 sets the multiplexer 251 so that the vector input B is retrieved from the registers of the selected column. The method then proceeds to block 720, described below. If, at block 714, the matrix engine 120 determines that the vector input B source is a vector register or portion of a tile register, the method flow moves to block 718 and the matrix engine 120 sets the multiplexer 251 so that the vector input B is retrieved from the vector register or selected portion of the tile register. The method flow then proceeds to block 720.

At block 720, the set 245 of arithmetic elements executes the arithmetic operations specified by the operation (e.g., multiply and accumulate operations). At block 722, the matrix engine 120 determines if all operations for the instruction have been executed. If not, the matrix engine 120 proceeds to the next operation and the method flow returns to block 706. If the final operation for the instruction has been executed, the method flow moves to block 724 and the processing system 100 stores the result of the instruction at a register or other storage location indicated by the instruction.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A matrix engine, comprising:
a plurality of arithmetic elements; and
a first multiplexor configured to select, based on a first instruction, a first sequence of vector inputs for the plurality of arithmetic elements.

2. The matrix engine of claim 1, further comprising:
a second multiplexor configured to select, based on the first instruction, a second sequence of vector inputs for the plurality of arithmetic elements.

3. The matrix engine of claim 2, wherein:
the plurality of arithmetic elements are arranged in a plurality of rows and columns;
the first multiplexor is configured to select the first sequence of vector inputs for the plurality of rows; and
the second multiplexor is configured to select the second sequence of vector inputs for the plurality of columns.

4. The matrix engine of claim 2, wherein at least one arithmetic element of the plurality of arithmetic elements includes:
a register to store arithmetic results of the at least one arithmetic element; and
wherein the register includes a first output port coupled to the first multiplexor, the first multiplexor configured to select the first output port based on the first instruction.

5. The matrix engine of claim 4, wherein:
the register includes a second output port coupled to the second multiplexor, the second multiplexor configured to select the first output port based on the first instruction.

6. The matrix engine of claim 1, wherein:
the first multiplexor is configured to select, based on a second instruction, a second sequence of vector inputs for the plurality of arithmetic elements, the second sequence different from the first sequence.

7. The matrix engine of claim 6, wherein the first sequence of vector inputs corresponds to a matrix multiplication operation.

8. The matrix engine of claim 7, wherein the second sequence of vector inputs corresponds to a vector multiplication operation.

9. The matrix engine of claim 1, wherein the first sequence of vector inputs corresponds to a matrix transposition operation.

10. A processing system, comprising:
a memory to store a plurality of instructions including a first instruction; and
a processor including a matrix engine, the matrix engine including:
a plurality of arithmetic elements; and
a first multiplexor configured to select, based on a first instruction, a first sequence of vector inputs for the plurality of arithmetic elements.

11. The processing system of claim 10, wherein the matrix engine further comprises:
a second multiplexor configured to select, based on the first instruction, a second sequence of vector inputs for the plurality of arithmetic elements.

12. The processing system of claim 11, wherein:
the plurality of arithmetic elements are arranged in a plurality of rows and columns;
the first multiplexor is configured to select the first sequence of vector inputs for the plurality of rows; and
the second multiplexor is configured to select the second sequence of vector inputs for the plurality of columns.

13. The processing system of claim 11, wherein at least one arithmetic element of the plurality of arithmetic elements includes:
a register to store arithmetic results of the at least one arithmetic element; and
wherein the register includes a first output port coupled to the first multiplexor, the first multiplexor configured to select the first output port based on the first instruction.

14. The processing system of claim 13, wherein:
the register includes a second output port coupled to the second multiplexor, the second multiplexor configured to select the first output port based on the first instruction.

15. The processing system of claim 10, wherein:
the first multiplexor is configured to select, based on a second instruction, a second sequence of vector inputs for the plurality of arithmetic elements, the second sequence different from the first sequence.

16. The processing system of claim 15, wherein the first sequence of vector inputs corresponds to a matrix multiplication operation.

17. The processing system of claim 16, wherein the second sequence of vector inputs corresponds to a vector multiplication operation.

18. The matrix engine of claim 10, wherein the first sequence of vector inputs corresponds to a matrix transposition operation.

19. A method, comprising:
selecting, at a first multiplexor and based on a first instruction, a first sequence of vector inputs; and
at a plurality of arithmetic elements of a matrix engine, executing arithmetic operations with the first sequence of vector inputs.

20. The method of claim 19, further comprising:
selecting, at a second multiplexor and based on the first instruction, a second sequence of vector inputs for the plurality of arithmetic elements; and
at the plurality of arithmetic elements of a matrix engine, executing the arithmetic operations with the second sequence of vector inputs.
